(19) United States
(12) Patent Application Publication
(10) Pub. No.: US 2025/0293778 A1
(43) Pub. Date: Sep. 18, 2025

(54) Signal Adapter Device and Network System

(71) Applicant: Moxa Inc., New Taipei City (TW)

(72) Inventors: Zong-Han Li, New Taipei City (TW); Jui-Cheng Han, New Taipei City (TW)

(73) Assignee: Moxa Inc., New Taipei City (TW)

(21) Appl. No.: 18/757,448

(22) Filed: Jun. 27, 2024

(30) Foreign Application Priority Data
Mar. 14, 2024 (TW) 113109409

(51) Int. Cl. H04B 10/40; H04B 10/25

(52) U.S. Cl. CPC H04B 10/40; H04B 10/25

(57) ABSTRACT

A signal adapter device, covered with a small form-factor pluggable (SFP) module, the signal adapter device includes an input interface; a transceiver, coupled to the input interface, configured to receive a first data signal through the input interface, and convert the first data signal into a second data signal; a boost circuit, coupled to the input interface, configured to receive a first supply power having a first voltage through the input interface, and convert the first supply power into a second supply power having a second voltage, wherein the second voltage is greater than the first voltage; a mixing circuit, coupled to the transceiver and the boost circuit, configured to mix the second data signal and the second supply power into an output signal; and an output interface, coupled to the mixing circuit, configured to output the output signal.

### BACKGROUND OF THE INVENTION

### 1. Field of the Invention

The present invention relates to a signal adapter device and a network system, and more particularly, to a signal adapter device and a network system whose output signal includes a data signal and a supply power.

### 2. Description of the Prior Art

In the field of network, a switch may output data signals to various devices via optical fibers. In many scenarios of the industrial networks or home networks, some devices can only receive data signals from the copper wire signal lines, for example, a single-pair Ethernet (SPE) connector or an RJ-45 connector. Under the circumstance, the switch can be coupled to a signal adapter covered with a small package pluggable module and convert the data signal to be output by the SPE connector or the RJ-45 connector. In addition, some devices have very low power consumption, such as a light sensor, a temperature sensor, etc. If these devices can receive the data signals and supply power at the same time through the SPE connector or the RJ-45 connector, the devices do not need an external power supply. Therefore, how to make the output signal of the signal adapter include both data signals and supply power has become one of the goals of the industry.

### SUMMARY OF THE INVENTION

Therefore, the purpose of the present invention is to provide a signal adapter device and a network system to solve the above problem.

The embodiment of the present invention discloses a signal adapter device, covered with a small form-factor pluggable (SFP) module. The signal adapter device comprises an input interface; a transceiver, coupled to the input interface, configured to receive a first data signal through the input interface, and convert the first data signal into a second data signal; a boost circuit, coupled to the input interface, configured to receive a first supply power having a first voltage through the input interface, and convert the first supply power into a second supply power having a second voltage, wherein the second voltage is greater than the first voltage; a mixing circuit, coupled to the transceiver and the boost circuit, configured to mix the second data signal and the second supply power into an output signal; and an output interface, coupled to the mixing circuit, configured to output the output signal.

The embodiment of the present invention discloses a network system comprising a switch; a network terminal equipment; and a signal adapter device, coupled to the switch and the network terminal equipment, and covered with a small form-factor pluggable (SFP) module, the signal adapter device comprising: an input interface, coupled to the switch; a transceiver, coupled to the input interface, configured to receive a first data signal from the switch through the input interface, and convert the first data signal into a second data signal; a boost circuit, coupled to the input interface, configured to receive a first supply power having a first voltage from the switch through the input interface, and convert the first supply power into a second supply power having a second voltage, wherein the second voltage is greater than the first voltage; a mixing circuit, coupled to the transceiver and the boost circuit, configured to mix the second data signal and the second supply power into an output signal; and an output interface, coupled to the mixing circuit and the network terminal equipment, configured to output the output signal to the network terminal equipment.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a network system according to an embodiment of the present invention.

FIG. 2 is a schematic diagram of the SFP signal adapter device according to an embodiment of the present invention.

FIG. 3 is a schematic diagram of a mixing circuit according to an embodiment of the present invention.

FIG. 4 is a schematic diagram of a network system according to another embodiment of the present invention.

FIG. 5 is a schematic diagram of a network system according to another embodiment of the present invention.

### DETAILED DESCRIPTION

Certain terms are used throughout the description and following claims to refer to particular components. As one skilled in the art will appreciate, hardware manufacturers may refer to a component by different names. This document does not intend to distinguish between components that differ in name but not function. In the following description and in the claims, the terms “include” and “comprise” are utilized in an open-ended fashion, and thus should be interpreted to mean “include, but not limited to”. Also, the term “couple” is intended to mean either an indirect or direct electrical connection. Accordingly, if one device is coupled to another device, that connection may be through a direct electrical connection, or through an indirect electrical connection via other devices and connections.

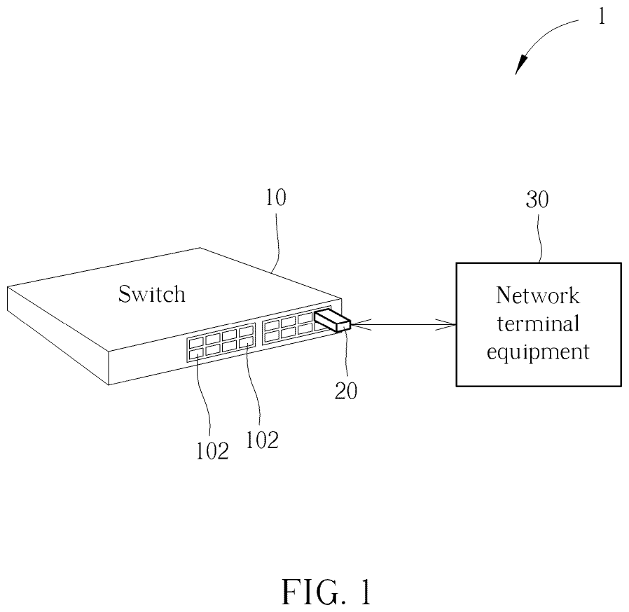

Please refer to FIG. 1. FIG. 1 is a schematic diagram of a network system 1 according to an embodiment of the present invention. The network system 1 includes a switch 10, a signal adapter device 20 and a network terminal equipment 30. The switch 10 includes a plurality of output ports 102. Each output port of the plurality of output ports 102 supports a small form-factor pluggable (SFP) module and is configured to transmit optical signals. The signal adapter device 20 is covered with the SFP module, and is configured to convert the optical signals into electrical signals. For convenience of description, the following is referred to as The SFP signal adapter device 20. It should be noted that the optical signals transmitted by the SFP signal adapter device 20 may be an optical signal in an optical fiber network format, but not limited thereto. When the SFP signal adapter device 20 is coupled to the output port 102, the network terminal equipment 30 may receive a supply power and transmit the data signals through the SFP signal adapter device 20 and the output port 102. It should be noted that the SFP signal adapter device 20 is required to comply with the power specifications of the small form-factor pluggable module protocol SFF-8419; that is, the power provided by the SFP signal adapter device 20 is less than 1.0 watt, 1.5 watts or 2.0 watts. Therefore, the required power for the normal operation of the network terminal equipment 30 must also be less than the power provided by the SFP signal adapter device 20. In other words, the network terminal equipment 30 may include a light sensor, a temperature sensor, etc. that consumes less power, but not limited thereto. In addition, compared with the power over Ethernet (POE) specification in IEEE 802.3af, the power provided by the PoE is as high as 15.4 watts. Therefore, the solution of the PoE is not suitable for the SFP signal adapter device 20 of the embodiment of the present invention.

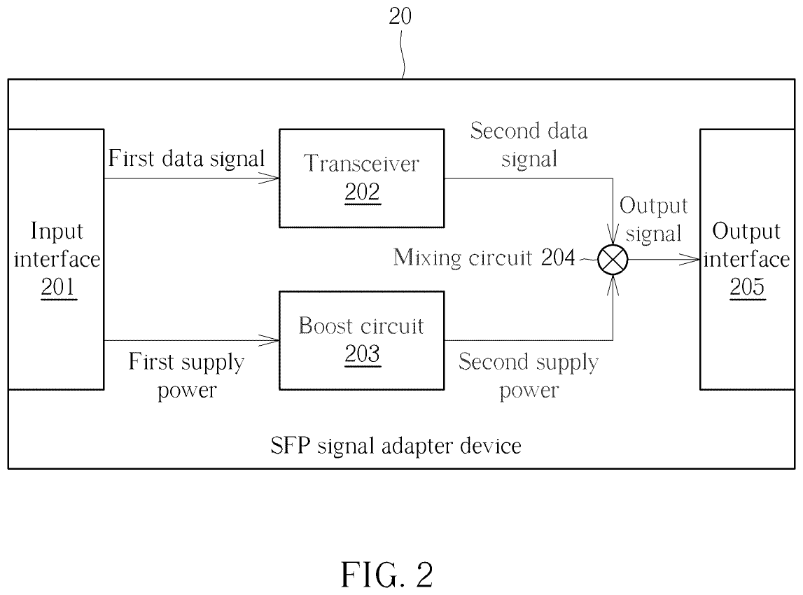

In detail, please refer to FIG. 2. FIG. 2 is a schematic diagram of the SFP signal adapter device 20 according to an embodiment of the present invention. In the embodiment, the SFP signal adapter device 20 includes an input interface 201, a transceiver 202, a boost circuit 203, a mixing circuit 204 and an output interface 205. The input interface 201 is configured to couple to the switch 10 through the output port 102. The transceiver 202 is coupled to the input interface 201, and is configured to receive a first data signal from the switch 10 through the input interface 201 and the output port 102 and convert the first data signal into a second data signal. It should be noted that the output port 102 and the output interface 201 may be standard SFP male and female connectors respectively, and the first data signal from the switch 10 is the optical signal. The boost circuit 203 is coupled to the input interface 201, and is configured to receive a first supply power having a first voltage from the switch 10 through the input interface 201 and the output port 102 and convert the first voltage into a second supply power having a second voltage. It should be noted that the second voltage is greater than the first voltage; that is, the first supply power is boosted to the second supply power to be provided to subsequent devices. The mixing circuit 204 is coupled to the transceiver 202 and the boost circuit 203, and is configured to mix the second data signal and the second supply power into an output signal. The output interface 205 is coupled to the mixing circuit 204, and is configured to output the output signal to the network terminal equipment 30. It should be noted that the output interface 205 may be a connector that complies with an SPE standard (for convenience of description, hereafter referred to as the SPE connector) or an RJ-45 connector, but not limited thereto. In other words, the second data signal, the second supply power and the output signal are electrical signals that may be transmitted through the SPE connector or the RJ-45 connector. The SPE connector and its corresponding twisted pair, or the RJ-45 connector and its corresponding multiple-twisted wires are well known in the art, so it is not repeated here.

In short, the output signal of the SFP signal adapter device 20 includes the data signal and the supply power, so the network terminal equipment 30 may operate normally without the external power supply.

It should be noted that FIG. 1 and FIG. 2 are only embodiments of the present invention, and those skilled in the art may make appropriate adjustments according to the system requirements. For example, if the output interface 205 is the SPE connector, the SPE connector needs to comply with the specifications and the explosion-proof safety requirements of IEEE 802.3cg. In detail, the SPE connector needs to comply with the power supply standards class A and class C of the specification TS10186. The power supply standard class A specifies a maximum power supply voltage of 15 volts and a minimum power supply of 0.54 watts, and the power supply standard class C specifies a maximum power supply voltage of 15 volts and a minimum power supply of 1.11 watts. In an embodiment, the first supply power provided by the switch 10 may be a system power supply of 3.3 volts. The boost circuit 203 boosts the first supply power of 3.3 volts into the second supply power of 15 volts to comply the power supply standard class A or class C. Specifically, the boost circuit 203 may be a boost converter, a flyback converter, a (single-ended primary inductance converter or a Ćuk converter, but not limited thereto. For example, the boost converter includes a switch control circuit, diodes, energy storage inductors and passive components such as decoupling capacitors and feedback resistors. The design principle of the boost converter and other boost circuits should be well known in the art, so it is not repeated here.

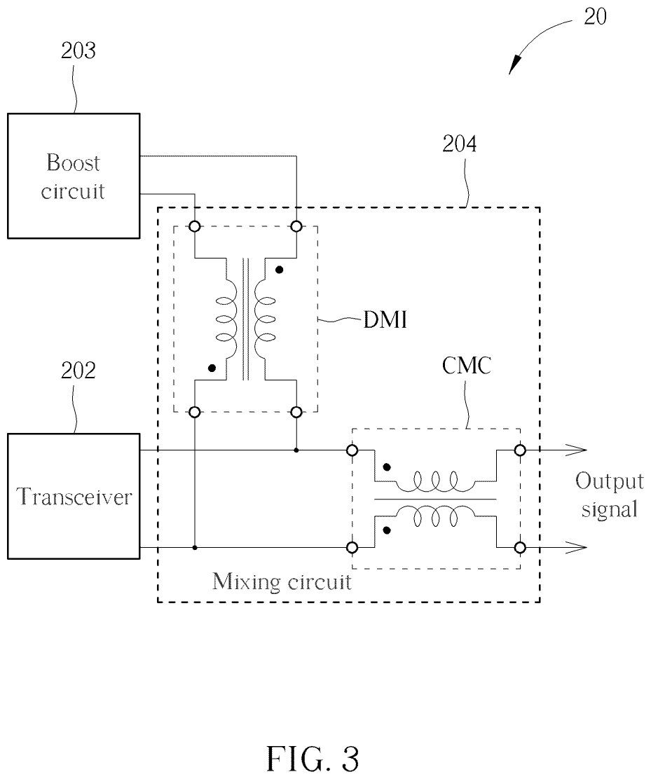

Please refer to FIG. 3. FIG. 3 is a schematic diagram of the mixing circuit 204 according to an embodiment of the present invention. In the embodiment, the mixing circuit 204 is an inductive coupling circuit, which includes a differential mode inductor DMI and a common mode inductor CMC. As shown in FIG. 3, the differential mode inductor DMI and the common mode inductor CMC couple the received second data signal and the received second supply power into the output signal. In another embodiment, the mixing circuit 204 may be a power injection circuit for injecting the second supply power into the second data signal to generate the output signal. The design principles of the inductive coupling circuit and the power injection circuit should be well known in the art, so they are not repeated here.

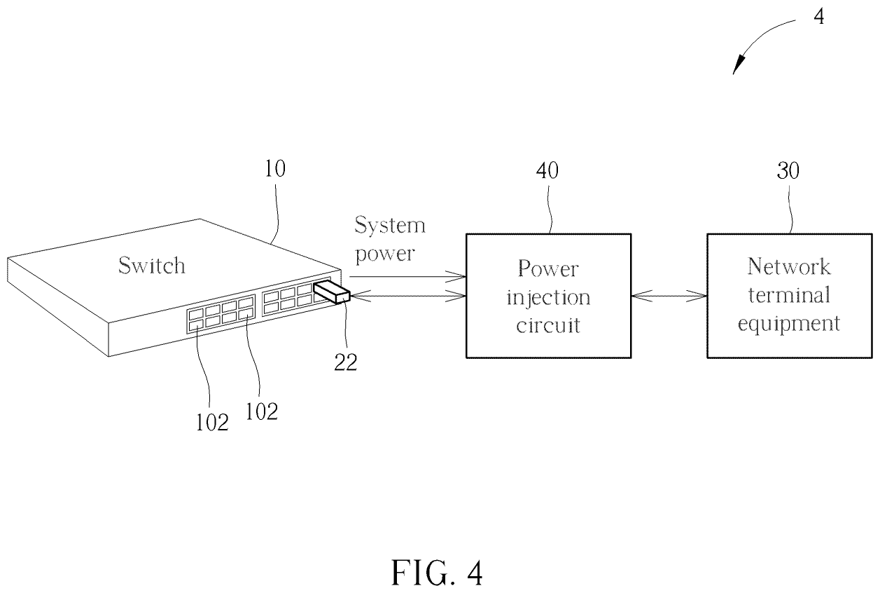

Please refer to FIG. 4. FIG. 4 is a schematic diagram of a network system 4 according to an embodiment of the present invention. The network system 4 is derived from the network system 1, so the same components are represented by the same symbols. The differences between the network system 4 and the network system 1 are an SFP signal adapter device 22 and an power injection circuit 40. In the embodiment, the SFP signal adapter device 22 converts the first data signal from the switch 10 into the second data signal, and directly outputs the second data signal to the power injection circuit 40. In addition, the SFP signal adapter device 22 uses a power processing circuit to replace the boost circuit 203 in the SFP signal adapter device 20, and the SFP signal adapter device 22 directly outputs the system power from the switch 10 to the power injection circuit 40 through the power processing circuit. The power injection circuit 40 may inject the system power into the second data signal and generate the output signal. In this way, after receiving the output signal, the network terminal equipment 30 may operate normally without the external power supply.

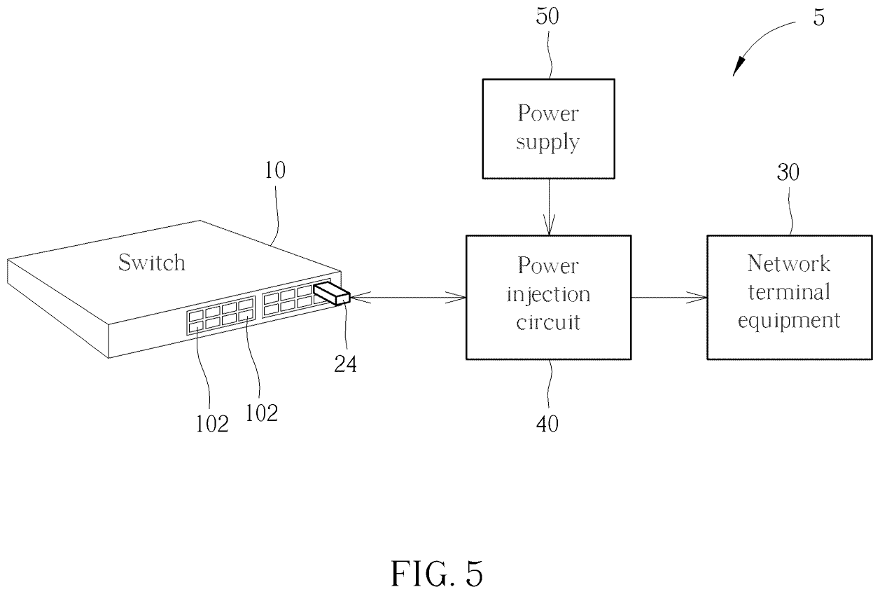

Please refer to FIG. 5. FIG. 5 is a schematic diagram of a network system 5 according to an embodiment of the present invention. The network system 5 is derived from the network system 4, so the same components are represented by the same symbols. The differences between the network system 5 and the network system 4 are the SFP switching device 24 and a power supply 50. In the embodiment, the SFP switching device 24 converts the first data signal from the switch 10 into the second data signal, and directly outputs to the power injection circuit 40. In addition, the power supply 50 provides an additional supply power to the power injection circuit 40. The power injection circuit 40 may inject the additional supply power into the second data signal and generate the output signal. In this way, after receiving the output signal, the network terminal equipment 30 may operate normally without the external power supply.

In summary, the SFP switching device of the present invention may convert the optical signal from the switch into the electrical signal, and then mix the system power and the electrical signal from the switch into the output signal. In this way, compared with the prior art, the output signal provided from the SFP switching device of the present invention may allow the terminal equipment to operate normally without connecting the external power supply to the terminal equipment.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A signal adapter device, covered with a small form-factor pluggable (SFP) module, the signal adapter device comprising:
an input interface;
a transceiver, coupled to the input interface, configured to receive a first data signal through the input interface, and convert the first data signal into a second data signal;
a boost circuit, coupled to the input interface, configured to receive a first supply power having a first voltage through the input interface, and convert the first supply power into a second supply power having a second voltage, wherein the second voltage is greater than the first voltage;
a mixing circuit, coupled to the transceiver and the boost circuit, configured to mix the second data signal and the second supply power into an output signal; and
an output interface, coupled to the mixing circuit, configured to output the output signal.

2. The signal adapter device of claim 1, wherein the boost circuit is a boost converter, a flyback converter, a single-ended primary inductance converter or a Ćuk converter.

3. The signal adapter device of claim 1, wherein the mixing circuit is an inductive coupling circuit, configured to couple the second supply power and the second data signal into the output signal.

4. The signal adapter device of claim 1, wherein the mixing circuit is a power injection circuit configured to inject the second supply power into the second data signal to generate the output signal.

5. The signal adapter device of claim 1, wherein the first voltage is 3.3 volts, and the second voltage is 15 volts.

6. The signal adapter device of claim 1, wherein an output power of the output signal is greater than 0.54 watts.

7. The signal adapter device of claim 1, wherein the input interface comprises an SFP male connector or an SFP female connector, and the first data signal is an optical signal.

8. The signal adapter device of claim 1, wherein the output interface comprises a single-pair Ethernet (SPE) connector or an RJ-45 connector.

9. A network system, comprising:
a switch;
a network terminal equipment; and
a signal adapter device, coupled to the switch and the network terminal equipment, and covered with a small form-factor pluggable (SFP) module, the signal adapter device comprising:
an input interface, coupled to the switch;
a transceiver, coupled to the input interface, configured to receive a first data signal from the switch through the input interface, and convert the first data signal into a second data signal;
a boost circuit, coupled to the input interface, configured to receive a first supply power having a first voltage from the switch through the input interface, and convert the first supply power into a second supply power having a second voltage, wherein the second voltage is greater than the first voltage;
a mixing circuit, coupled to the transceiver and the boost circuit, configured to mix the second data signal and the second supply power into an output signal; and
an output interface, coupled to the mixing circuit and the network terminal equipment, configured to output the output signal to the network terminal equipment.

10. The network system of claim 9, wherein the boost circuit is a boost converter, a flyback converter, a single-ended primary inductance converter or a Ćuk converter.

11. The network system of claim 9, wherein the mixing circuit the mixing circuit is an inductive coupling circuit, configured to couple the second supply power and the second data signal into the output signal.

12. The network system of claim 9, wherein the mixing circuit is a power injection circuit configured to inject the second supply power into the second data signal to generate the output signal.

13. The network system of claim 9, wherein the first voltage is 3.3 volts, and the second voltage is 15 volts.

14. The network system of claim 9, wherein an output power of the output signal is greater than 0.54 watts.

15. The network system of claim 9, wherein the input interface comprises an SFP male connector or an SFP female connector, and the first data signal is an optical signal.

16. The network system of claim 9, wherein the output interface comprises a single-pair Ethernet (SPE) connector or an RJ-45 connector.
